(19) United States
(12) Patent Application Publication
(10) Pub. No.: US 2013/0072417 A1
(43) Pub. Date: Mar. 21, 2013

(54) LIQUID DETERGENT COMPOSITION WITH ABRASIVE PARTICLES

(71) Applicant: The Procter & Gamble Company, Cincinnati, OH (US)

(72) Inventors: Eva Maria Perez-Prat Vinuesa, Singapore (SG); Denis Alfred Gonzales, Brussels (BE); Anna Asmanidou, Kampenhout (BE); Susana Fernandez Prieto, Benicarlo (ES)

(73) Assignee: The Procter & Gamble Company, Cincinnati, OH (US)

(21) Appl. No.: 13/621,860

(22) Filed: Sep. 18, 2012

(30) Foreign Application Priority Data
Sep. 20, 2011 (EP) 11181970.2

(51) Int. Cl. C11D 17/00

(52) U.S. Cl. 510/236

(57) ABSTRACT

A dishwashing composition comprising at least one surfactant, and natural abrasive particles wherein said natural abrasive particles comprise pistachio nut shell particles, a method of washing dishes with such compositions, and the use thereof.

### FIELD OF INVENTION

The present invention relates to a dishwashing composition comprising natural abrasive particles wherein said natural abrasive particles comprise pistachio nut shell particles, a method of washing dishes with such compositions and a use thereof.

### BACKGROUND OF THE INVENTION

Scouring compositions such as particulate compositions or liquid (including gel, paste-type) compositions containing abrasive components are well known in the art. Such compositions are used for cleaning and/or cleansing a variety of surfaces; especially those surfaces that tend to become soiled with difficult to remove stains and soils.

Natural particles, such as those derived from apricot seeds, have been used before in liquid compositions for driving cleaning benefits and improving sensory attributes to the skin whilst washing dishes. An example being WO2005/010138.

However, the problem associated with such products is that, due to the very nature of such seeds, an unpleasant brown residue may be left over a surface, particularly dishware, following treatment. This is undesirable since the user associates such residue with poor cleaning performance of the product.

Thus, there remains a need to provide a liquid hand dishwashing composition suitable to clean a variety of dishware surfaces, wherein the composition provides good cleaning performance of stubborn and hard to remove soils, mild skin exfoliation, and good surface safety profile, whilst at the same time providing an appealing aesthetics that provides perception of cleaning effectiveness.

There also remains a need for generating such particle aesthetics whilst minimizing cost and complexity of such a product.

### SUMMARY OF THE INVENTION

In one aspect, the present invention relates to a liquid hand dishwashing composition comprising at least one surfactant, and natural abrasive particles comprising pistachio nut shell particles.

In another aspect, the present invention relates to a method of washing dishes comprising the steps of treating a hard surface, preferably dishware, with a composition according to the present invention; optionally followed by a rinsing step.

In another aspect, the present invention relates to a use of pistachio nut shell particles in a hand dishwashing composition, for delivering a benefit selected from the group consisting of mild skin exfoliation, grease or stubborn soil cleaning, product aesthetics, and mixtures thereof.

### BRIEF DESCRIPTION OF THE FIGURES

FIG. 1 is an electron microscopy image showing pistachio nut shell particles.

FIG. 2 is an image showing different degree of whiteness in pistachio nut shells.

FIG. 3 is an image showing different degree defects in the surface of pistachio nut shells.

FIG. 4 is an illustration of the convex hull area and particle area.

### DETAILED DESCRIPTION OF THE INVENTION

As used herein “grease” means materials comprising at least in part (i.e., at least 0.5 wt % by weight of the grease) saturated and unsaturated fats and oils, preferably oils and fats derived from animal sources, such as beef and/or chicken; and/or vegetable sources.

As used herein “shelf stable” means a neat hand dishwashing liquid detergent composition that under ambient conditions does not phase separate for at least two weeks, preferably for at least six months, and more preferably never.

As used herein “dishware” refers to a hard surface such as dishes, glasses, pots, pans, baking dishes and flatware made from ceramic, china, metal, glass, plastic (polyethylene, polypropylene, polystyrene, etc.), wood, enamel, Inox®, Teflon®, or any other material commonly used in the making of articles used for eating and/or cooking.

As used herein “liquid dishwashing detergent composition” refers to those compositions that are employed in manual (i.e. hand) dishwashing. Such compositions are generally high sudsing or foaming in nature and are shelf stable.

As used herein “hand skin care benefit” means any benefit relating to hand skin appearance (such as smoothness, elasticity, absence of redness and absence of lines and wrinkles), skin feel (such as softness and suppleness), and skin moisture level.

As used herein “exfoliation or mild skin exfoliation” means removal of dead skin cells from the outermost layer of the skin whilst minimizing the risk of over-exfoliating the skin, which may otherwise result in damaged and red hands.

As used herein “suds profile” means amount of sudsing (high or low) and the persistence of sudsing (sustained or prevention) throughout the washing process resulting from the use of the liquid detergent composition of the present composition.

As used herein “stubborn soil” means strongly adhering soils that are typically very difficult to remove. Such soils comprise but are not limited to burnt-on and/or baked-on food residues.

As used herein “polyurethane foam” means a polyurethane structure having a lightweight cellular form resulting from the introduction of gas bubbles (or by other suitable means) during manufacture.

As used herein “polyurethane foam particles” means particles formed by shearing, grinding, milling, and/or graining polyurethane foam.

As used herein “polymeric material foam” means a polymeric structure having a lightweight cellular form resulting from the introduction of gas bubbles (or by other suitable means) during manufacture.

As used herein “natural abrasive particles” means particles derived from materials readily found in nature. Such particles are selected from the group consisting of nut shell particles; particles derived from other plant sources; and mixtures thereof.

As used herein, the term “average degree of whiteness (L*)” means the whiteness value (L*) of pistachio nut shell particle population, not whiteness of a single pistachio nut shell particle, as measured using the method described herein.

### Liquid Composition

The composition of the present invention is formulated as a liquid dishwashing detergent composition comprising abrasive particles comprising pistachio nut shell particles. Such compositions may be single phase and/or multiphase and be in liquid and/or gel form and/or may be provided in unit dose form. Furthermore, the compositions herein may comprise isotropic or non-lamellar phases, lamellar phases or mixtures thereof. It is generally accepted that lamellar phases are less preferred, however, in some embodiments, lamellar phases may be present. The liquid dishwashing compositions herein may further contain from 30% to 90% by weight of an aqueous liquid carrier that preferably comprises water, more preferably consists of water.

The liquid dishwashing composition may have any suitable pH. Preferably the pH of the composition is adjusted to between 4 and 14. Typically, the composition has pH of between 6 and 13, preferably between 7 and 10, more preferably between 7 and 9, and most preferably between 8 and 9. The pH of the composition can be adjusted using pH modifying ingredients known in the art.

### Abrasive Particles

The compositions herein comprise natural abrasive particles, however may also further comprise other abrasive particles such as polymeric abrasive particles.

The abrasive particle size may be important to achieve efficient cleaning performance whereas excessively abrasive population with small particle sizes e.g.: typically below 10 micrometers feature polishing action vs. cleaning despite featuring a high number of particles per particle weight load in cleaner inherent to the small particle size. On the other hand, abrasive population with excessively high particle size, e.g.: above 1000 micrometers, do not deliver optimal cleaning efficiency, because the number of particles per particle weight load in cleaner, decreases significantly inherently to the large particle size. Additionally, excessively small particle size are not desirable in cleaner/for cleaning task since in practice, small and numerous particles are often hard to remove from the various surface topologies which requires excessive effort by the user to remove, otherwise leaving the surface with visible particles residue. In addition, very small particles do not deliver the desired skin exfoliation experience as they are often not tactile detectable to the user and might increase the risk of over-exfoliating the skin as the user does not feel their action. However, excessively large particle are too easily detected visually or provide bad tactile experience while handling or using the cleaner. Therefore, the applicants define herein an optimal particle size range that delivers both optimal cleaning and exfoliating performance, and usage experience.

The abrasive particles have size defined by their area-equivalent diameter (ISO 9276-6:2008(E) section 7) also called Equivalent Circle Diameter ECD (ASTM F1877-05 Section 11.3.2). Mean ECD of particle population is calculated as the average of respective ECD of each particles of a particle population of at least 10 000 particles, preferably above 50 000 particles, more preferably above 100 000 particles after excluding from the measurement and calculation the data of particles having area-equivalent diameter (ECD) of below 10 micrometers. Mean data are extracted from volume-based vs. number-based measurements.

In a preferred embodiment, the abrasive particles have a mean ECD from 10 μm to 1000 μm, preferably from 50 μm to 500 μm, more preferably from 100 μm to 400 μm and most preferably from 150 to 355 μm.

### Natural Abrasive Particles

The natural abrasive particles described herein comprise pistachio nut shell particles. Such natural abrasive particles may also comprise particles selected from the group consisting of other nut shell particles; particles derived from other plant sources, such as but not limited to stems, roots, leaves, seeds, fruits, and/or wood; and mixtures thereof.

In a preferred embodiment, such natural abrasive particles are comprised at a level of greater than 0.5%, preferably greater or equal to 1%, more preferably greater or equal to 2%, even more preferably greater or equal to 2.5%, still more preferably from 2.5% to 10%, most preferably from 3% to 6%, by weight of the total composition.

In an embodiment, the natural abrasive particles are derived by shearing, graining, milling and/or grinding pistachio and/or other nut shells, preferably pistachio nut shells. Other suitable means include the use of eroding tools such as a high speed eroding wheel with dust collector wherein the surface of the wheel is engraved with a pattern or is coated with abrasive sandpaper or the like to form the abrasive cleaning particles herein.

Preferably, other nut shells are selected from the group consisting of walnut shell, almond shell, hazelnut shell, macadamia nut shell, pine nut shell and mixtures thereof. Most preferred other nut shell is walnut shell.

When other plant sources are comprised in the natural abrasive particles used in the compositions herein, they are preferably derived from rice, corn cob, palm biomass, bamboo, kenaf, loofa, apple seeds, apricot stone, olive stone, cherry stone, peach stone, Tagua palm (Phyleteas genus) seed, Doum palm (Hyphaene genus) seed, Sago palm (Metroxylon genus) seed, wood and mixtures thereof. Preferred are particles derived from wood, olive stone, cherry stone, tagua palm seed endosperm (known as vegetable ivory), and mixtures thereof.

When the natural abrasive particles are derived from other nut shells or other plant sources, they may be coated, coloured, and/or bleached in any suitable manner available in the art to achieve particles with an appearance that can provide a more appealing product aesthetics. This may also help to inhibit bacterial, mold or fungus growth.

The natural abrasive particles of the present invention provide a dual benefit to the user: Firstly, excellent removal of tough food soils from dishware without substantially damaging delicate surfaces such as stainless steel, Inox®, Teflon®, painted and or decorated ceramic, crystal, and plastics; and secondly, hand skin care benefits, mainly skin softness/smoothness and improved skin appearance, through mild skin exfoliation.

In a most preferred embodiment, the natural abrasive particles consist of pistachio nut shell particles. Without wishing to be bound by theory it is believed that the pistachio nut shell attains the required cleaning, surface safety, and exfoliation requirements but also improves product aesthetics due to the whiteness of its shell. Thanks to such whiteness of the shell, coating and/or bleaching is no longer necessary in order to attain the desired product aesthetics, thus permitting savings in terms of both cost and manufacturing complexity.

The natural abrasive particles used in compositions herein are preferably white having average degree of whiteness (L*) of greater than 65, preferably greater than 75, more preferably greater or equal to 80, measured under D 65 illumination.

As source for pistachio shell feedstock from which the natural abrasive particle are produced, a number of pistachio species have been found suitable for compositions herein, such as Pistachia L. vera, Pistachia terebinthus, Pistachia altantica, Pistachia chinensis, Pistachia integerrima, Pistachia khinjuk, Pistachia mutica, Pistachia lentiscus, Pistachia acurainata, etc. However, the more preferred species are Pistachia L. vera, Pistachia terebinthus, Pistachia altantica and the most preferred species is Pistachia L. vera due to its ability to produce higher yield of light or white colored shell in addition to higher yield of dehiscent shell e.g.: shell-opening during the nut maturation which helps the separation process of the fruit from the shell. More especially, among the pistachio varieties, preferred cultivars are selected from the group consisting of Kerman, Muntaz, Pontikis, Sirora, Joley, Cerasola, Aegina, Bronte, Trabonella, Red Aleppo, Damghan, and Lassen due to their ability to produce higher yield of light or white shell featuring average degree of whiteness (L*) typically above 65 and most preferred cultivar is Kerman due to its ability to produce higher yield of shell with average degree of whiteness (L*) typically above 70.

FIG. 1 is an electron microscopy image showing pistachio nut shell particles. (from Pistachia L. vera, cultivar Kerman)

Most of the natural-occurring materials like Pistachio nuts suffer from internal defect e.g.: genetic alteration or defect in maturation process or alternatively undergo external spoiling/rottening phenomenon or alternatively are spoiled and/or stained during the harvesting process. Therefore, the pistachio feedstock preferably undergo a sorting process in order to sort out pistachio shells not fitting with the whiteness requirement as well as other foreign bodies.

The sorting process can be done manually, however, it is more effectively achieved with automatic sorting machinery e.g.: equipped with optical camera and digital imaging software compatible with the measurement of the degree of whiteness (L*) similarly to the method defined herein below, however this time in relation to the pistachio nut shell total surface rather than the particle population. Examples of suitable sorting equipment include Buhler Sortex serie modified to measure (L*) value and compute surface area ratio based on (L*) value, and adapted to detect and discard individual pistachio nut shells having an (L*) value of less than 65, preferably less than 60, over more than 10% of the total surface area of the pistachio nut shell.

The sorting can be executed before or after shelling the nut, however, prior to the grinding the shell into the abrasive particles. The shells, after being separated from the nuts, are used to produce the pistachio shell abrasive particles.

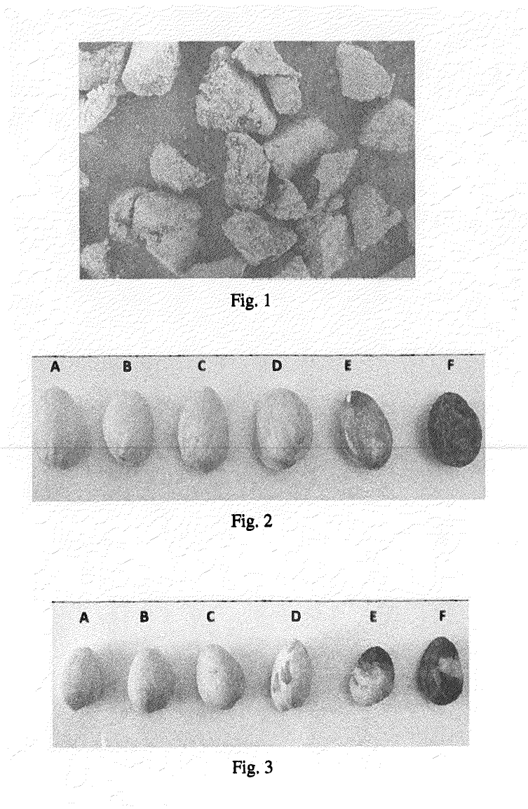

FIG. 2 illustrates sorting pistachio nut shells accordingly to degree of whiteness. Shells A, B and C are suitable for generating pistachio nut shell particles for use in the present invention. Shells D, E and F, on the other hand, are not suitable to be used in the present invention.

FIG. 3 illustrates sorting pistachio nut shells according to degree of whiteness and to shell defect(s). Shells A, B, and C are suitable for generating pistachio nut shell particles for use in the present invention. Shells D, E and F, on the other hand, are not suitable to be used in the present invention.

Typically, as a consequence of a selection process such as the above, the pistachio species and cultivars, and the settings of the sorting process of the pistachio nut shells according to the L* value, the selected pistachio nut shell particles feature an average degree of whiteness (L*) above 65, more preferably above 75 and most preferably of greater or equal to 80.

Whiter particles are highly preferred as they deliver more pleasing product aesthetics to consumers. Particles derived from darker nut shells or other plant sources tend to give a brown aesthetics which is very undesirable for a cleaning product. Additionally, during cleaning, residual brown particles may be left on the surface and can be perceived as a dark residue that compromises the overall cleaning efficiency of the cleaning products.

In a highly preferred embodiment herein, the pistachio shell material may be reduced to particles in several stages. First the bulk pistachio nut shell can be broken into pieces of a few mm dimensions by manually chopping or cutting, or using a mechanical tool such as a lump-breaker, for example the Model 2036 from S Howes, Inc. of Silver Creek, N.Y. In a second stage, the lumps are agitated using a propeller or saw toothed disc dispersing tool, which causes the pistachio nut shells to release entrapped water and form liquid slurry of pistachio nut shell particles dispersed in aqueous phase. In a third stage, a high shear mixer (such as the Ultra Turrax rotor stator mixer from IKA Works, Inc., Wilmington, N.C.) can be employed to reduce the particle size of the primary slurry to that required for cleaning particles. Preferably the reduction process of pistachio shell into particles is set to not reach excessive temperature which risk to discolor the abrasive particles.

If the particles are colored, coated and/or bleached suitable color stabilizing agents can be used to stabilize desired color and/or whiteness.

Whiteness Measurement:

The whiteness value of pistachio nut shell particle population is measured using for instance Gretag machbeath™ 7000 a color-eye instrument or equivalent used in reflectance mode. This instrument provides a choice of light sources; “D65” represents roughly a mid-day sun in western and northern Europe, whilst “illuminant A” is intended to represent typical, domestic, tungsten-filament lighting and “CWF2” represents cool white fluorescent. The instrument thus provides a standard measure of whiteness (L*) that can be determined for daylight, tungsten and fluorescent lighting conditions. Under each set of lightning conditions L* is defined such that 100 is fully white and 0 has no white components. For the purposes of the present invention, the “D65” illuminant is used to measure whiteness.

Samples are prepared by filling pistachio nut shell particles in a holder to ensure good packing of the particle so to make a continuous layer of material, which is pelletized under pressure. Measurements are made by placing the pelletized pistachio shell particle population sample in the holder of the color-eye instrument. The view area is 3 mm by 8 mm with degree observer angle 10°. The specular component is included. Measurements are generally made duplicate and an average was taken.

### Combination of Natural Abrasive Particles and Other Abrasive Particles

The compositions herein may further comprise other abrasive particles such as polymeric abrasive particles. Preferably, all abrasive particles will have a Shore D hardness of below 90 according to a procedure described in ASTM D2240.

Most preferably all abrasive particles have substantially the same degree of whiteness L* as the selected pistachio nut shell particle population.

Without wishing to be bound by theory, it is believed that, overall, the combination of both natural and polymeric abrasive particles allows to formulate an effective hand dishwashing formulation with lower total load of abrasives in the formulation which is desirable in order to reduce cost as well as to increase the rheology and aesthetic profiles of the final composition.

In a preferred embodiment, when the composition comprises both natural abrasive particles and polymeric abrasive particles, the ratio of natural abrasive particles to polymeric abrasive particles is from 50 to 1, preferably from 20 to 1, more preferably from 10 to 1, even more preferably from 5 to 1.

In an embodiment the level of natural abrasive particles is from 2% to 6%, preferably from 2.5% to 5%, more preferably from 2.5% to 4%, most preferably from 2.5% to 3%, by weight of the composition, and the level of polymeric abrasive particles is from 0.1% to 2.5%, preferably from 0.1% to 1%, more preferably from 0.1% to 0.5%, even more preferably from 0.1% to 0.25%, by weight of the composition.

In one embodiment the polymeric abrasive particles herein may be produced by shearing, graining, milling and/or grinding a polymeric material foam, preferably rigid in form. Without wishing to be bound by theory is believed that effective cleaning synergy is achieved when mixing polymeric and natural abrasives both featuring effective shape for cleaning. The applicant has found that grinding polymeric material foam is a particularly preferred process to produce polymeric abrasives with effective shape, although other less preferred processes are also possible such as printing, extruding, molding, etc.

The polymeric material may be selected from the group consisting of polyurethane; polyhydroxy alkanoate derivatives (PHA) such as but not limited to polyhydroxy butyrate, polyhydroxy hexanoate, polyhydroxy valerate, polyhydroxy butyrate-valerate, polyhydroxy butyrate-hexanoate and mixtures thereof; aliphatic polyesters such as polybutylene succinate (PBS), polybutylene adipate (PBA), polybutylene succinate-co-adipate (PBSA) and mixtures thereof; polylactic acid derivatives (PLA); polystyrene; melamine-formaldehyde; polyacrylate; polyolefins such as polyethylene, polypropylene; polyvinyl chloride; and/or polyvinyl acetate. Most preferred is polyurethane.

Most preferably the polymeric abrasive particles are made from a rigid polyurethane foam formed in the reaction between diisocyanate monomers and polyols.

### Shape of the Natural Abrasive Particles

Natural abrasive particles suitable for use in the compositions described herein are preferably selected to have specific geometries and shapes. Such particles may be selected to feature effective shapes, e.g.: defined by circularity.

In a preferred embodiment the abrasive particles are non-rolling. e.g.: defined by circularity to promote effective sliding of the abrasive particles vs. typical abrasive particles, where rolling is rather promoted. The natural abrasive particles have a mean circularity from 0.1 to 0.7, preferably from 0.3 to 0.6 and more preferably from 0.4 to 0.5 typically for providing improved cleaning performance, surface safety and mild skin exfoliating benefits. Mean data are extracted from volume-based vs. number-based measurements according to the method described herein below.

### Shape of the Polymeric Abrasive Particles

Polymeric abrasive cleaning particles having a mean circularity from 0.1 to 0.4, preferably from 0.15 to 0.35 and more preferably from 0.2 to 0.35 are particularly preferred as they typically provide the desired improved cleaning performance surface safety and mild skin exfoliating benefits. Mean data are extracted from volume-based vs. number-based measurements according to the method described herein below.

In a preferred embodiment polymeric abrasive particles further have a mean solidity from 0.4 to 0.75, preferably from 0.5 to 0.7 and more preferably from 0.55 to 0.65 are providing improved cleaning performance surface safety and mild skin exfoliating benefits. Mean data are extracted from volume-based vs. number-based measurements according to the method described herein below.

### Shape and Size Analysis

The shape of an abrasive particle can be defined in a number of ways. Preferred is to define the abrasive particle shape in a form of particle, which reflects the geometrical proportions of a particle and more pragmatically of the particle population. Very recent analytical techniques allow an accurate simultaneous measurement of particle shapes from a large number of particles, typically greater than 10000 particles (preferably above 100 000). This enables accurate tuning and/or selection of average particle population shape with discriminative performance. These measurement analyses of particle shape are conducted using on Occhio Nano 500 Particle Characterisation Instrument with its accompanying software Callistro version 25 (Occhio s.a. Liege, Belgium). This instrument is used to prepare, disperse, image and analyse the particle samples, as per manufacturer's instructions, and the following instrument setting selections: White Requested=180, vacuum time=5000 ms, sedimentation time=5000 ms, automatic threshold, number of particles counted/analyses=8000 to 500000, minimum number of replicates/sample=3, lens setting 1×/1.5×.

The abrasive particles for use herein may be defined by quantitative description of a shape. In quantitative description, shape descriptor is understood as numbers that can be calculated from particle images or physical particle properties via mathematical or numerical operations. While particle shape can be defined in 3-dimension with dedicated analytical technique, the applicant has found, that the characterization of the particles shape in 2-dimension is most relevant and correlates with the abrasive performance of the abrasive particles. During the particle shape analysis protocol, the particles are orientated toward the surface—via gravity deposition—similarly to the expected particle orientation during the cleaning process. Hence, it is preferred to characterize the 2-D shape of a particle/particle population as defined by the projection of its shape on the surface on which the particle/particle population is deposited.

Circularity

Circularity is a quantitative, 2-dimension image analysis shape description and is being measured according to ISO 9276-6:2008(E) section 8.2 as implemented via the Occhio Nano 500 Particle Characterisation Instrument with its accompanying software Callistro version 25 (Occhio s.a. Liege, Belgium). Circularity is a preferred mesoshape descriptor and is widely available in shape analysis instrument such as in Occhio Nano 500 or in Malvern Morphologi G3. Circularity is sometimes described in literature as being the difference between a particle's shape and a perfect sphere. Circularity values range from 0 to 1, where a circularity of 1 describes a perfectly spherical particles or disc particle as measured in a two dimensional image.

$$C = \sqrt{\frac{4 π A}{{P}^{2}}}$$

Where A is projection area, which is 2D descriptor and P is the length of the perimeter of the particle.

Solidity

Solidity is a quantitative, 2-dimensional image analysis shape description, and is being measured according to ISO 9276-6:2008(E) section 8.2 as implemented via the Occhio Nano 500 Particle Characterisation Instrument with its accompanying software Callistro version 25 (Occhio s.a. Liege, Belgium). The particle herein has preferably at least one edge or surface having a concave curvature. Solidity is a mesoshape parameter, which describes the overall concavity of a particle/particle population. Solidity values range from 0 to 1, where a solidity number of 1 describes a non-concave particle, as measured in literature as being:

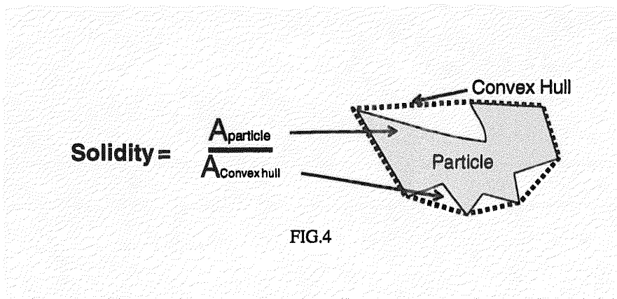

Solidity=A/Ac

Where A is the area of the abrasive particle and Ac is the area of the convex hull (or convex envelope) bounding the abrasive particle. The area of the convex hull is better understood with the aid of FIG. 4. In FIG. 4, the convex hull is clearly identified by the dotted line that connects all outermost edges of the abrasive particle, and the area of the convex hull is the area enclosed therein.

Solidity is sometime also named convexity in literature or in some apparatus software using the solidity formula in place of its definition described in ISO 9276-6 (convexity=Pc/P where P is the length of the perimeter of the abrasive particle and P_{C} is length of the perimeter of the convex hull—envelope—bounding the particle). Despite solidity and convexity being similar mesoshape descriptor in concept, the applicant refers herein to the solidity measure expressed above by the Occhio Nano 500, as indicated above.

By the term “mean circularity” or “mean solidity”, the applicant considers the average of the circularity or solidity values of each abrasive particle taken from a population of at least 10 000 abrasive particles, preferably above 50 000 abrasive particles, more preferably above 100 000 abrasive particles, after excluding from the measurement and calculation, the circularity or solidity or roughness data of abrasive particles having area-equivalent diameter (ECD) of below 10 microns. Mean data are extracted from volume-based vs. number-based measurements.

### Hardness of the Particles

Preferred abrasive particles suitable for use herein are hard enough to provide good cleaning/cleansing performance, whilst providing a good surface safety profile, and highly desirable mild skin exfoliation.

Preferred are abrasive particles having a Shore D hardness of from 40 to 90, preferably from 50 to 90, more preferably from 60 to 85, even more preferably from 70 to 80, according to ASTM D2240-05 (2010).

### Suspending Aids

The present invention may comprise one or more suspending aids selected from the group consisting of crystalline wax suspending aids, amido-gellants, micro fibril cellulose (MFC), di-benzylidene polyol acetal derivatives, and mixtures thereof. These suspending aids may form a thread-like structuring system throughout the matrix of the composition that prevents the abrasive particles from sedimenting or creaming in the product, thereby providing excellent stability of a hand dishwashing liquid composition. Such stability allows formulating particles of densities different from that of the liquid composition, and of the preferred particle size (i.e. area-equivalent diameter) of 50 to 400 microns, more preferably 150 to 355 microns to deliver efficient cleaning without damaging delicate surfaces, and highly desirable mild skin exfoliation.

When present, said crystalline wax suspending aid will typically be comprised at a level of from 0.02% to 5%, preferably 0.025% to 3%, more preferably from 0.05% to 2%, most preferably from 0.1% to 1.5% by weight of the total composition. Preferred crystalline wax suspending aids are hydroxyl-containing crystalline suspending aids such as a hydroxyl-containing fatty acid, fatty ester or fatty soap wax-like materials. Said crystalline hydroxyl-containing suspending aids are insoluble in water under ambient to near ambient conditions.

The preferred crystalline hydroxyl-containing suspending aids are selected from the group consisting of suspending aids with formula (I), (II), or mixtures thereof.

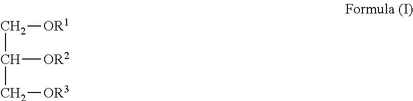

Wherein R¹ is the chemical moiety described below

### R¹

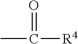

### R² is R¹ or H

### R³ is R¹ or H

R⁴ is independently C₁₀-C₂₂ alkyl or alkenyl comprising at least one hydroxyl group;

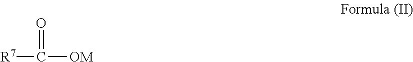

wherein: R⁷ is R⁴ as defined above in (I), M is Na⁺, K⁺, Mg⁺⁺ or Al³⁺, or H,

Some preferred hydroxyl-containing suspending aids include 12-hydroxystearic acid, 9,10-dihydroxystearic acid, tri-9,10-dihydroxystearin and tri-12-hydroxystearin. Tri-12-hydroxystearin is most preferred for use in the hand liquid dishwashing compositions herein.

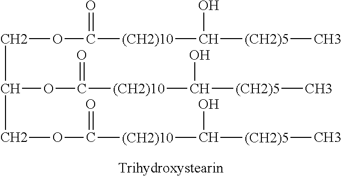

Castor wax or hydrogenated castor oil is produced by the hydrogenation (saturation of triglyceride fatty acids) of pure castor oil and is mainly composed of tri-12-hydroxistearin. Commercially available, castor oil-based, crystalline, hydroxyl-containing suspending aids include THIXCIN® from Rheox, Inc. (now Elementis).

Another preferred suspending aid for use in the present invention is micro fibril cellulose (MFC) such as described in US 2008/0108714 (CP Kelco) or US2010/0210501 (P&G): micro fibril cellulose, bacterially derived or otherwise, can be used to provide suspension of particulates in surfactant-thickened systems as well as in formulations with high surfactant concentrations. Such MFC is usually present at concentrations from about 0.01% to about 1%, but the concentration will depend on the desired product. For example, while from 0.02 to 0.05% is preferred for suspending small mica platelets in liquid detergent compositions, higher levels might be needed to suspend larger particles. Preferably, MFC is used with co-agents and/or co-processing agents such as CMC, xanthan, and/or guar gum with the microfibrous. US2008/0108714 describes MFC in combination with xanthan gum, and CMC in a ratio of 6:3:1, and MFC, guar gum, and CMC in a ratio of 3:1:1. These blends allow to prepare MFC as a dry product which can be “activated” with high shear or high extensional mixing into water or other water-based solutions. “Activation” occurs when the MFC blends are added to water and the co-agents/co-processing agents are hydrated. After the hydration of the co-agents/co-processing agents, high shear is generally then needed to effectively disperse the MFC to produce a three-dimensional functional network that exhibits a true yield point. One example of a commercially available MFC is Cellulon® from CPKelko.

In another preferred embodiment, the suspending aid system may comprise a di-amido gellant having a molecular weight from 150 g/mol to 1500 g/mol, preferably between 500 g/mol and 900 g/mol. Such di-amido gellants may comprise at least two nitrogen atoms, wherein at least two of said nitrogen atoms form amido functional substitution groups. In one embodiment, the amido groups are different. In a preferred embodiment, the amido functional groups are the same. The di-amido gellant has the following formula:

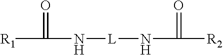

wherein:
R₁ and R₂ is an amino functional end-group, preferably amido functional end-group, more preferably R₁ and R₂ may comprise a pH-tuneable group, wherein the pH tuneable amido-gellant may have a pKa of from 1 to 30, more preferably between 2 and 10. In a preferred embodiment, the pH tuneable group may comprise a pyridine. In one embodiment, R₁ and R₂ may be different. In a preferred embodiment, may be the same.
L is a linking moeity of molecular weight from 14 to 500 g/mol. In one embodiment, L may comprise a carbon chain comprising between 2 and 20 carbon atoms. In another embodiment, L may comprise a pH-tuneable group. In a preferred embodiment, the pH tuneable group is a secondary amine.

In one embodiment, at least one of R¹, R² or L may comprise a pH-tuneable group.

Non-limiting examples of di-amido gellants are:

### N,N′-(2S,2′S)-1,1′-(dodecane-1,12-diylbis(azanediyl))bis(3-methyl-1-oxobutane-2,1-diyl)diisonicotinamide

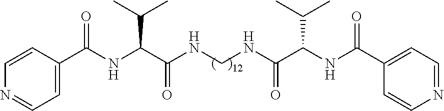

### dibenzyl (2S,2′S)-1,1′-(propane-1,3-diylbis(azanediyl))bis(3-methyl-1-oxobutane-2,1-diyl)dicarbamate

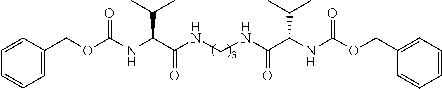

### dibenzyl (2S,2′S)-1,1′-(dodecane-1,12-diylbis(azanediyl))bis(1-oxo-3-phenylpropane-2,1-diyl)dicarbamate

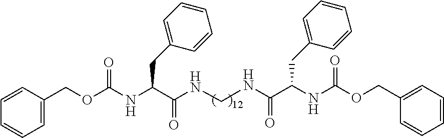

Another preferred embodiment includes Di-benzylidene Polyol Acetal Derivatives (DBPA). The fluid detergent composition may comprise from 0.01% to 1% by weight of a dibenzylidene polyol acetal derivative (DBPA), preferably from 0.05% to 0.8%, more preferably from 0.1% to 0.6%, most preferably from 0.3% to 0.5%. In one embodiment, the DBPA derivative may comprise a dibenzylidene sorbitol acetal derivative (DBS), such as the ones described in U.S. Pat. No. 6,102,999 to Cobb et al. at col. 2, line 43—col. 3, line 65. In another embodiment, the DBPA derivative comprises a sorbitol derivative, a ribitol derivative, a xylitol derivative, a tartrate, or a mixture thereof.

### The Hydrophobic Emollient

The composition of present invention may comprise one or more hydrophobic emollients. Hydrophobic emollients are agents that soften or soothe the skin by slowing the evaporation of water. Hydrophobic emollients form an oily layer on the surface of the skin that slows water loss increasing skin moisture content and skin water holding capacity. Without wishing to be bound by theory, it is believed that the hydrophobic emollient complements the skin care benefit provided by the exfoliating particles of the present invention by soothing the exfoliated skin. When a hydrophobic emollient is present, said liquid dishwashing composition according to the present invention comprises high levels of hydrophobic emollient, typically up to 10% by weight. The hydrophobic emollient is preferably present from 0.25% to 10%, more preferably from 0.3% to 8%, most preferably from 0.5% to 6% by weight of the total composition.

Hydrophobic emollients suitable for use in the compositions herein are hydrocarbon oils and waxes; silicones; fatty acid derivatives; glyceride esters, di and tri-glycerides, acetoglyceride esters; alkyl and alkenyl esters; cholesterol and cholesterol derivatives; vegetable oils, vegetable oil derivatives, liquid nondigestible oils, or blends of liquid digestible or nondigestible oils with solid polyol polyesters; natural waxes such as lanolin and its derivatives, beeswax and its derivatives, spermaceti, candelilla, and carnauba waxes; phospholipids such as lecithin and its derivatives; sphingolipids such as ceramide; and mixtures thereof.

Preferred hydrophobic emollients are hydrocarbons like petrolatum, mineral oil and/or blends of petrolatum and mineral oil; tri-glycerides such as the ones derived from vegetable oils including castor oil, soy bean oil, safflower oil, cotton seed oil, corn oil, walnut oil, peanut oil, olive oil, almond oil, avocado oil, coconut oil, jojoba oil, cocoa butter, and the like; oily sugar derivatives such as esters of sucrose with fatty acids; beeswax; lanolin and its derivatives including but not restricted to lanolin oil, lanolin wax, lanolin alcohols, lanolin fatty acids, isopropyl lanolate, cetylated lanolin, acetylated lanolin alcohols, lanolin alcohol linoleate, lanolin alcohol riconoleate, and ethoxylated lanolin.

### Surfactants

The present invention comprises at least one surfactant. Suitable surfactants are selected from the group consisting of nonionic, anionic, cationic surfactants, amphoteric, zwitterionic, semi-polar nonionic surfactants, and mixtures thereof. Surfactants may be comprised at a level of from about 1.0% to about 50% by weight, preferably from about 5% to about 40% by weight, more preferably about 10% to about 30% by weight and even more preferably from about 5% to about 20% by weight of the liquid detergent composition. Non-limiting examples of suitable surfactants are discussed below.

In a preferred embodiment, an efficient but mild to hands surfactant system will typically comprise about 4% to about 40%, preferably about 6% to about 32%, more preferably about 11% to about 25%, and most preferably about 11% to about 18% by weight of the total composition of an anionic surfactant and so preferably with no more than about 15%, preferably no more than about 10%, more preferably no more than about 5% by weight of the total composition, of a sulfonate surfactant.

Suitable anionic surfactants to be used in the compositions and methods of the present invention are sulfate, sulfosuccinates, sulfonate, and/or sulfoacetate; preferably alkyl sulfate and/or alkyl ethoxy sulfates; more preferably a combination of alkyl sulfates and/or alkyl ethoxy sulfates with a combined ethoxylation degree less than about 5, preferably less than about 3, more preferably less than about 2.

In an alternative embodiment, the surfactant system could be based on high levels of nonionic surfactant (Such as about 10% to about 45%, preferably about 15 to about 40%, more preferably about 20 to about 35% by weight of the total composition), preferably combined with an amphoteric surfactant, and more preferably with a low level of anionic surfactant (such as less than 20%, preferably less than 10%, more preferably less than about 5% by weight of the total composition).

### Sulfate Surfactants

Suitable surfactants for use in the compositions herein include water-soluble salts or acids of C₁₀-C₁₄ alkyl or hydroxyalkyl, sulfate and/or ether sulfate. Suitable counterions include hydrogen, alkali metal cation or ammonium or substituted ammonium, but preferably sodium.

Where the hydrocarbyl chain is branched, it preferably comprises C₁₋₄ alkyl branching units. The average percentage branching of the sulfate surfactant is preferably greater than 30%, more preferably from 35% to 80% and most preferably from 40% to 60% of the total hydrocarbyl chains.

The sulfate surfactants may be selected from C₈-C₂₀ primary, branched-chain and random alkyl sulfates (AS); C₁₀-C₁₈ secondary (2,3) alkyl sulfates; C₁₀-C₁₈ alkyl alkoxy sulfates (AEₓS) wherein preferably x is from 1-30; C₁₀-C₁₈ alkyl alkoxy carboxylates preferably comprising 1-5 ethoxy units; mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303.

### Alkyl Sulfosuccinates—Sulfoacetate

Other suitable anionic surfactants are alkyl, preferably dialkyl, sulfosuccinates and/or sulfoacetate. The dialkyl sulfosuccinates may be a C₆₋₁₅ linear or branched dialkyl sulfosuccinate. The alkyl moieties may be symmetrical (i.e., the same alkyl moieties) or asymmetrical (i.e., different alkyl moiety.es). Preferably, the alkyl moiety is symmetrical.

### Sulfonate Surfactants

The compositions of the present invention will preferably comprise no more than 10% by weight, preferably no more than 8%, even more preferably no more than 5% by weight of the total composition, of a sulfonate surfactant. These include water-soluble salts or acids of C₁₀-C₁₄ alkyl or hydroxyalkyl, sulfonates; C₁₁-C₁₈ alkyl benzene sulfonates (LAS), modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548; methyl ester sulfonate (MES); and alpha-olefin sulfonate (AOS). These also include the paraffin sulfonates may be monosulfonates and/or disulfonates, obtained by sulfonating paraffins of 10 to 20 carbon atoms. The sulfonate surfactants also include the alkyl glyceryl sulfonate surfactants.

### Amphoteric and Zwitterionic Surfactants

The amphoteric and zwitterionic surfactant may be comprised at a level of from 0.01% to 20%, preferably from 0.2% to 15%, more preferably 0.5% to 12% by weight of the liquid detergent composition. Suitable amphoteric and zwitterionic surfactants are amine oxides and betaines.

Most preferred are amine oxides, especially coco dimethyl amine oxide or coco amido propyl dimethyl amine oxide. Amine oxide may have a linear or mid-branched alkyl moiety. Typical linear amine oxides include water-soluble amine oxides of formula R¹—N(R²)(R³)→(O) wherein R¹ is a C₈₋₁₈ alkyl moiety; R² and R³ are independently selected from the group consisting of C₁₋₃ alkyl groups and C₁₋₃ hydroxyalkyl groups and preferably include methyl, ethyl, propyl, isopropyl, 2-hydroxethyl, 2-hydroxypropyl and 3-hydroxypropyl. The linear amine oxide surfactants in particular may include linear C₁₀-C₁₈ alkyl dimethyl amine oxides and linear C₈-C₁₂ alkoxy ethyl dihydroxy ethyl amine oxides. Preferred amine oxides include linear C₁₀, linear C₁₀-C₁₂, and linear C₁₂-C₁₄ alkyl dimethyl amine oxides. As used herein “mid-branched” means that the amine oxide has one alkyl moiety having n₁ carbon atoms with one alkyl branch on the alkyl moiety having n₂ carbon atoms. The alkyl branch is located on the a carbon from the nitrogen on the alkyl moiety. This type of branching for the amine oxide is also known in the art as an internal amine oxide. The total sum of n₁ and n₂ is from 10 to 24 carbon atoms, preferably from 12 to 20, and more preferably from 10 to 16. The number of carbon atoms for the one alkyl moiety (n₁) should be approximately the same number of carbon atoms as the one alkyl branch (n₂) such that the one alkyl moiety and the one alkyl branch are symmetric. As used herein “symmetric” means that |n₁−n₂| is less than or equal to 5, preferably 4, most preferably from 0 to 4 carbon atoms in at least 50 wt %, more preferably at least 75 wt % to 100 wt % of the mid-branched amine oxides for use herein.

The amine oxide further comprises two moieties, independently selected from a C₁₋₃ alkyl, a C₁₋₃ hydroxyalkyl group, or a polyethylene oxide group containing an average of from about 1 to about 3 ethylene oxide groups. Preferably the two moieties are selected from a C₁₋₃ alkyl, more preferably both are selected as a C₁ alkyl.

Other suitable surfactants include betaines such alkyl betaines, alkylamidobetaine, imidazoliniumbetaine, sulfobetaine (INCI Sultaines), and phosphobetaine.

Examples of suitable betaines and sulfobetaine are the following [designated in accordance with INCI]: almondamidopropyl betaines, apricotamidopropyl betaines, avocadamidopropyl betaines, babassuamidopropyl betaines, behenamidopropyl betaines, behenyl betaines, canolamidopropyl betaines, capryl/capramidopropyl betaines, alkyl derivatives of carnitine, cetyl betaines, cocamidoethyl betaines, cocamidopropyl betaines, cocamidopropyl hydroxysultaine, coco betaines, coco hydroxysultaine, coco/oleamidopropyl betaines, coco sultaine, decyl betaines, dihydroxyethyl oleyl glycinate, dihydroxyethyl soy glycinate, dihydroxyethyl stearyl glycinate, dihydroxyethyl tallow glycinate, dimethicone propyl pg-betaines, erucamidopropyl hydroxysultaine, hydrogenated tallow betaines, isostearamidopropyl betaines, lauramidopropyl betaines, lauryl betaines, lauryl hydroxysultaine, lauryl sultaine, milkamidopropyl betaines, minkamidopropyl betaines, myristamidopropyl betaines, myristyl betaines, oleamidopropyl betaines, oleamidopropyl hydroxysultaine, oleyl betaines, olivamidopropyl betaines, palmamidopropyl betaines, palmitamidopropyl betaines, palmitoyl carnitine, palm kernelamidopropyl betaines, polytetrafluoroethylene acetoxypropyl betaines, ricinoleic amidopropyl betaines, sesamidopropyl betaines, soyamidopropyl betaines, stearamidopropyl betaines, stearyl betaines, tallow amidopropyl betaines, tallow amidopropyl hydroxysultaine, tallow betaines, tallow dihydroxyethyl betaines, undecylenamidopropyl betaines and wheat germamidopropyl betaines. A preferred betaine is, for example, cocoamidopropyl betaine.

A preferred surfactant system is a mixture of anionic surfactant and amphoteric or zwiterionic surfactants in a ratio within the range of 1:1 to 5:1, preferably from 1:1 to 3.5:1.

It has been found that such surfactant system will provide the excellent cleaning and suds profile required from a hand dishwashing liquid composition while being mild to the hands.

### Nonionic Surfactants

Nonionic surfactant, when present as co-surfactant, is comprised in a typical amount of from 0.1% to 20%, preferably 0.5% to 15%, more preferably from 0.5% to 10% by weight of the liquid detergent composition. When present as main surfactant, it is comprised in a typical amount of from 0.1 to 45%, preferably 15 to 40%, more preferably 20 to 35% by weight of the total composition. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 moles of ethylene oxide per mole of alcohol.

Also suitable are alkylpolyglycosides having the formula R²O(CₙH₂ₙO)ₜ(glycosyl)ₓ (formula (III)), wherein R² of formula (III) is selected from the group consisting of alkyl, alkyl-phenyl, hydroxyalkyl, hydroxyalkylphenyl, and mixtures thereof in which the alkyl groups contain from 10 to 18, preferably from 12 to 14, carbon atoms; n of formula (III) is 2 or 3, preferably 2; t of formula (III) is from 0 to 10, preferably 0; and x of formula (III) is from 1.3 to 10, preferably from 1.3 to 3, most preferably from 1.3 to 2.7. The glycosyl is preferably derived from glucose. Also suitable are alkylglycerol ethers and sorbitan esters.

Also suitable are fatty acid amide surfactants having an alkyl group containing from 7 to 21, preferably from 9 to 17, carbon atoms and an amide group selected from C₈-C₂₀ ammonia amides, monoethanolamides, diethanolamides, and isopropanolamides.

### Cationic Surfactants

Cationic surfactants, when present in the composition, are present in an effective amount, more preferably from 0.1% to 20%, by weight of the liquid detergent composition. Suitable cationic surfactants are quaternary ammonium surfactants. Suitable quaternary ammonium surfactants are selected from the group consisting of mono C₆-C₁₆, preferably C₆-C₁₀ N-alkyl or alkenyl ammonium surfactants, wherein the remaining N positions are substituted by methyl, hydroxyehthyl or hydroxypropyl groups. Another preferred cationic surfactant is an C₆-C₁₈ alkyl or alkenyl ester of a quaternary ammonium alcohol, such as quaternary chlorine esters.

### Pearlescent Agent and Opacifiers

The composition of the present invention may comprise either an organic and/or an inorganic pearlescent agent and/or an opacifier in order to provide a composition which is substantially opaque (not substantially clear). A composition is “substantially opaque” as intended herein, if it transmits at most 50% of light at any one wavelength in the visible region i.e. between 400 and 800 nm, preferably 550-700 nm, measured in a 1 cm cuvette in absence of dyes and abrasive particles. Preferably the transmittance is at most 30%, more preferably at most 20%. Pearlescent agents and/or opacifiers may make the aesthetics of the particle-containing product more appealing to consumers.

### Other Optional Components

The liquid detergent compositions herein can further comprise a number of other optional ingredients suitable for use in liquid detergent compositions such as Magnesium ions, solvents, hydrotropes, polymeric suds stabilizers, alkoxylated polyethyleneimine polymers, cationic polymers, polymeric rheology modifiers, linear or cyclic carboxylic acids, diamines, humectants, enzymes such as protease, perfume, dyes, chelants, skin rejuvenating agents, pH buffering means. A further discussion of acceptable optional ingredients suitable for use in light-duty liquid detergent composition may be found in U.S. Pat. No. 5,798,505.

### Thickness of the Composition

The liquid hand dishwashing compositions herein have preferably a viscosity from 100 to 10000 mPa*s (100-10000 centipoises), more preferably from 200 to 8000 mPa*s (200-8000 centipoises), even more preferably from 400-6500 mPa*s (400-6500 centipoises), and most preferably from 800 to 5000 mPa*s (800-5000 centipoises) at 3.06 s⁻¹ and 20° C. Viscosity can be determined by conventional methods. Viscosity according to the present invention is measured using a Brookfield viscometer LVDV II with a cylindrical steel spindle (spindle number 31) according to the manufacturer instructions.

The preferred rheology described therein may be achieved using internal existing structuring with detergent ingredients or by employing an external rheology modifier and/or a suspending aid, which provides the composition with a pseudoplastic or shear thinning rheology profile and with time-dependent recovery of viscosity after shearing (thixotropy).

### The Method of Cleaning/Treating a Dishware

The method of washing dishes comprises the steps of treating a hard surface, preferably dishware, with a composition as described herein; optionally allowing the soil or stain to deposit and toughen; and optionally repeating the treating step, and optionally rinsing said surface prior or after allowing the soil or stain to deposit and toughen, and/or prior or after said treatment step.

By “in its neat form”, it is meant herein that said liquid composition is applied directly onto the surface to be treated and/or onto a cleaning device or implement such as a dish cloth, a sponge or a dish brush without undergoing any dilution by the user (immediately) prior to the application. By “diluted form”, it is meant herein that said liquid composition is diluted by the user with an appropriate solvent, typically water. By “rinsing”, it is meant herein contacting the dishware cleaned with the process according to the present invention with substantial quantities of appropriate solvent, typically water, after the step of applying the liquid composition herein onto said dishware. By “substantial quantities”, it is meant typically 5 to 20 liters.

### Method of Use

The method of delivering a benefit selected from the group consisting of mild skin exfoliation, grease or soil cleaning, product aesthetics, and mixtures thereof; to a surface, preferably dishware, the skin, or a product; comprising the step of contacting said surface with a composition as described herein, optionally followed by a rinsing step. As used herein the term “product” refers to the final composition as described herein, ready for placement in a suitable container.

### Cleaning Performance Test Method

First time “neat” product cleaning performance may be evaluated by the following test method: Tiles, typically glossy, white, enamel 24 cm×4 cm, are prepared by applying to them either 0.6 g pure vegetable oil mix (peanut, sunflower and corn oil at equal proportions) or 0.5 g Knorr white sauce mix (prepared according to the manufacturer instructions). Soils are spread using a paint roller to obtain a uniform layer on top of the tile. Tiles are baked in an oven at 145° C. for 2 hours and 10 minutes (vegetable oil mix) or at 180° C. for 45 minutes (white sauce) and kept in a constant temperature and humidity cabinet (25° C., 70% relative humidity) until used. To test cleaning performance, tiles are placed on a Wet Abrasion Scrub Tester with four cleaning tracks equipped with four sponge holders (such as made by Sheen Instruments Ltd. Kingston, England). Four new cellulose kitchen sponges (such as Spontex®) of dimensions 4 cm×8.5 cm (and 4.5 cm thick) are wetted with 25 g of water at 15 gpg water hardness and placed in the sponge holders. Four g of either test or reference compositions are applied to the sponges. Sponge holders are turned down so that the sponges are placed directly on top of the soiled tile. The abrasion tester can be configured to supply pressure (e.g. 200 g, 400 g, 600 g or 700 g), and move the sponge over the test surface with a set stroke length (e.g.: 30 cm), at set speed (e.g.: 37 strokes per minute). The ability of the composition to remove soil is measured through the number of strokes needed to perfectly clean the surface, as determined by visual assessment. In this context, one stroke means a single movement of the carriage equipped with the four sponges comprising the cleaning product over the tile to be cleaned. The lower the number of strokes, the higher the cleaning ability of the composition.

The soil is regarded as having been removed fully when the operator can no longer see the soil with the naked eye. Eight soiled tiles are used per test and the product position is randomized so that each product is tested in the four different cleaning tracks of the wet Abrasion Scrub Tester at least once. Results are shown in Example 1.

### Surface Damage Method

To measure the surface damage produced by the test particles, 4 g of aqueous solutions comprising the particles of the present invention (3%-5% wt particle in deionized water) are applied to new cellulose kitchen sponges (such as Spontex®) of dimensions 4 cm×8.5 cm (and 4.5 cm thick) wetted with 25 g of deionized water mounted on a Wet Abrasion Scrub Tester Instrument as described in the cleaning performance test method with the particle coated side facing the test surface. Two references are used: Reference 1 is the same cellulose kitchen sponge wetted with 25 g deionized water and loaded with 4 g water no particles, Reference 2 is a medium duty scrubbing sponge such as the ones sold by 3M under the trade mark of Scotch-Brite, placed in the Wet Abrasion Scrub tester sponge holder with the green scrubby side facing the test surface, wetted and loaded as Reference 1 sponge. The test surface to be used should be a new sheet of uncolored, transparent, virgin Poly(methyl methacrylate) (also known as PMMA, Plexiglass, Perspex, Lucite), having a Vickers HV Hardness Value of 25 kg/square mm (+/−2) (as measured using standard test method ISO 14577). The abrasion tester should be configured to supply 600 g of pressure and move the sponge over the test surface with a stroke length of 30 cm, at a speed of 37 strokes per minute. The wet abrasion scrub tester should be allowed to execute 200 strokes (i.e., 200 single-direction displacements), then the sponge is re-loaded with an additional 4 g of abrasive particles in water. The sponge is to be reloaded in this manner every 200 strokes, for five consecutive loadings (i.e., 1000 strokes in total per test surface). Assessment of damage to the test surface is conducted after 1000 strokes have been completed. To assess surface damage on the Poly(methyl methacrylate) test surface, visual grading is conducted according to the following 5-level surface damage grading scale: 0=I see no scratches; 1=I think I see scratches; 2=I definitely see small scratches; 3=I see lots of scratches; 4=I see a lot of damage. The Visual Damage Grade is the average of the grades given by 2 independent graders. Results are shown in Example 2.

### Exfoliation Method

“In vivo” exfoliation method is based on removal of dihydroxyacetone-induced skin artificial coloration. Dihydroxyacetone has the ability to stain only fully keratinized cells of the epidermis. Removal of the dihydroxyacetone-induced stain is linked to the removal of fully keratinized cells and therefore can provide an estimate of skin exfoliation.

The volar forearm area of both left and right arms of two volunteers is artificially tanned using a commercially available sunless tanner comprising dihydroxyacetone. The sunless tanner is applied once a day during a week according to the manufacturer instructions until a homogeneous artificial tan is obtained.

Three treatment sites per arm are marked off using a water proof marker. The three treatments sites of each arm should be centered on the volar forearm between the wrist and inner elbow. Care should be taken not to use the area closest to inner elbow and wrist. One of the 3 treatment sites in each forearm is a non-particle control which is included to demonstrate the exfoliation benefits provided by the particles. The location of both the non-particle control site and the two particle treatment sites are randomized for each arm and each subject to minimize position effects.

Product treatments: 0.5 ml of each prototype is applied twice a day with at least four hours between product applications for a total of 4 times in their designated treatment site of each forearm. Product is dispensed on the skin using a 2 ml syringe and rubbed with a gloved finger for 10 seconds with circular motions, after all products have been applied in one forearm, skin is rinsed with warm tap water and patted dry with a soft paper tissue taking care not to rub the treatment sites. Skin color measurements are taken as L*,a*,b* values according to the CIELab color scale using a BYK spectro-guide gloss 6801 before each product application, and one hour after the last (4^{th}) product application, according to the equipment instructions. The CIELab color scale is based on the Opponent-Colors Theory which assumes that the human eye perceives color as the following pairs of opposites: Light-Dark, Red-Green, Yellow-Blue. The L* value for each scale indicates the level of light or dark, the a* value the redness or greenness, and the b* value the yellowness or blueness.

Exfoliation benefits provided by the exemplified hand dish products comprising abrasive particles are shown in TABLE 4, in Example 3, by a decrease in the b* value (color removal) after each treatment (T1 to T4) with particle-containing product, and by the difference in b* value (Δb*) between the color of artificially tanned skin before initiating the product treatment (b* BT) and after the last (4^{th}) treatment (b* T4), so that Δb*=b* BT−b* T4. Larger Δb* indicate more color removal and more skin exfoliation. The impact of the particles can be seen by the increase in the Δb* after treatment with the particle-containing prototypes. Similarly, skin treated with the particle prototypes shows a b* value closer to that of not tanned (untreated) skin measured in the inner part of the upper arm and that has an average b* of 15.77, demonstrating that the prototypes with particles are more efficient in removing the layer of dead cells stained with the sunless tanner, and in returning the skin to its original color.

### Example 1

TABLE 1
Cleaning performance of exemplified hand dishwashing detergent
compositions comprising natural abrasive particles consisting
of pistachio nut shell particles.

| Composition | Comparative 1 | A | Comparative 2 |
|---|---|---|---|
| Alkyl Ethoxy Sulfate | 24 | 24 | 24 |
| AExS | | | |
| Dimehtyl coco alkyl | 5.3 | 5.3 | 5.3 |
| Amine Oxide | | | |
| Ethanol | 3.25 | 3.25 | 3.25 |
| Polypropyleneglycol | 0.7 | 0.7 | 0.7 |
| NaCl | 1.25 | 1.25 | 1.25 |
| Hydrogenated Castor | 0.24 | 0.24 | 0.24 |
| Oil | | | |
| Particles | — | 3% wt | 5% wt |
| | | Pistachio shell | walnut shell |
| | | particles (250-375 | particles (2) |
| | | microns) (1) | |
| Minors* | Balance to 100% with water | | |
| pH | 9 | 9 | 9 |
| Number of strokes | 28.8 ± 1.49 | 7.4 ± 0.74 | 10.5 ± 1.77 |
| (vegetable grease) | | | |

(1) EcoShell 80 shore D hardness
(2) Bleached walnut shell particles of 200 microns. Evonic Industries 75 shore D hardness.

### Example 2

TABLE 2
Visual surface damage grade of exemplified cleaning and abrasive particles
dispersed in deionized water at the indicated levels.

| Sample | Visual Surface damage Grading |
|---|---|
| 3% Polyurethane foam particles (1) | 0 |
| 5% Pistachio shell particles (2) | 0 |
| 5% Walnut shell particles (3) | 0 |
| Reference 1-Soft sponge + water | 0 |
| Reference 2-Scrubby sponge + water | 3 |

(1) From foam having foam density 33 kg/m³ / 60-90 shore D hardness / Blade mill grinded and sieved fraction 50-355 microns
(2) Particle size ~200 microns. EcoShell, 80 shore D hardness
(3) Particle size of 200 microns. Evonik Industries, 75 shore D hardness

### Example 3

TABLE 3
Exemplified hand dishwashing detergent compositions comprising abrasive
particles.

| Composition | Comparative 3 | B |
|---|---|---|
| Alkyl Ethoxy Sulfate | 18 | 18 |
| AExS | | |
| Dimehtyl coco alkyl | 6 | 6 |
| Amine Oxide | | |
| Citrate | 2.55 | 2.55 |
| Polypropyleneglycol | 0.8 | 0.8 |
| NaCl | 0.5 | 0.5 |
| Particles | — | 5% pistachio shell |
| | | particles 250-375 |
| | | microns (1) |
| Hydrogenated Castor | 0.24 | 0.24 |
| Oil | | |
| Minors* | Balance to 100% | |
| pH | 9 | 9 |

(1) Ecoshell / 80 shore D hardness

TABLE 4
Average b* value before treatment and after treatment with each product
four times

| | Dyed skin before treatment | |
|---|---|---|
| | with hand dish prototypes | |
| Product | (BT) | Δb* BT-T4 |
| Comparative 3 | 22.71 | 1.02 |
| B | 23.51 | 3.85 |

### Example 4

### Liquid Dishwashing Detergent Compositions

| % Weight | C | D | E | F | G | H | I | J | K | L | M |
|---|---|---|---|---|---|---|---|---|---|---|---|
| Alkyl Ethoxy | 18 | 24 | 14 | 14 | 9 | — | 5 | 9 | 18 | 24 | 15.2 |
| Sulfate | | | | | | | | | | | |
| Linear Alkylbenzene | — | — | — | — | 11 | — | 15 | 4 | — | — | — |
| Sulfonate | | | | | | | | | | | |
| Paraffin Sulfonate | — | — | — | 8 | — | — | — | — | — | — | — |
| Coco amido propyl | — | — | — | — | 6 | — | — | 4 | — | — | — |
| Betaine | | | | | | | | | | | |
| Ethoxylated alkyl | — | — | — | 3 | 2 | 33 | 1 | — | — | — | 4.7 |
| alcohol | | | | | | | | | | | |
| Dimehtyl coco alkyl | 6 | 5.3 | 4 | — | 2 | 2 | — | — | 6 | 5.3 | 5.1 |
| Amine Oxide | | | | | | | | | | | |
| Alkylpolyglucoside | — | — | — | 6 | — | — | 6 | — | — | — | — |
| Ethanol | — | 1.5 | 3 | 3 | 1 | 9 | 2 | 3 | — | 1.5 | 0.7 |
| Polypropyleneglycol | 0.8 | 0.7 | 0.2 | — | 0.5 | 0.3 | 0.2 | — | 0.8 | 0.7 | 0.25 |
| Citrate | 2.5 | — | | 0.3 | — | — | — | — | 2.5 | — | — |
| NaCl | 0.5 | 1.25 | — | — | 0.25 | — | — | 0.5 | 0.5 | 1.25 | 0.5 |
| Sodium cumene | — | — | — | 0.6 | — | 3 | 2 | 2 | — | — | — |
| sulfonate | | | | | | | | | | | |
| Glutamic acid-N,N- | — | — | — | 0.3 | 0.6 | — | — | 0.5 | — | — | 0.7 |
| diacetic acid | | | | | | | | | | | |
| (GLDA) | | | | | | | | | | | |
| Polyurethane foam | — | — | — | — | — | 1 | 0.5 | 0.25 | — | — | — |
| particles (1) | | | | | | | | | | | |
| Polyhydroxybutyrate | — | — | — | — | — | — | — | — | 2 | — | — |
| valerate foam | | | | | | | | | | | |
| particles (2) | | | | | | | | | | | |
| Polylactic acid foam | — | — | — | — | — | — | — | — | — | 1.5 | — |
| particles (3) | | | | | | | | | | | |
| Bleached Walnut | 5 | — | — | 3 | — | — | 2.5 | — | — | — | — |
| shell particles ~ 200 | | | | | | | | | | | |
| microns (4) | | | | | | | | | | | |
| Olive stone particles | — | — | 3 | — | 5.5 | — | — | — | — | 2.5 | — |
| 150-250 microns(5) | | | | | | | | | | | |
| Pistachio shell | 1 | 4 | 1.5 | 2 | 0.5 | 2 | 0.5 | 2.5 | 0.25 | 0.5 | 3 |
| particles 250-375 | | | | | | | | | | | |
| microns (6) | | | | | | | | | | | |
| Cationic polymer (7) | 0.1 | — | — | — | — | 0.2 | — | — | — | 0.15 | 0.1 |
| Hydrogenated | — | 0.3 | 0.2 | — | 0.2 | — | — | 0.1 | — | — | — |
| Castor Oil | | | | | | | | | | | |
| MFC CP Kelko | 0.15 | — | 0.02 | 0.05 | — | 0.03 | 0.1 | — | — | — | 0.2 |
| Dibenzylidene | — | — | — | — | — | — | — | — | 0.3 | — | — |
| Sorbitol (8) | | | | | | | | | | | |
| Amido-gellant (9) | — | — | — | 0.2 | — | — | — | — | — | 0.25 | — |
| Ethylene glycol | 0.4 | — | — | — | — | 0.8 | — | 0.4 | — | 0.3 | 0.35 |
| diesterate | | | | | | | | | | | |
| Opacifier (10) | — | — | 0.05 | — | 0.02 | — | — | 0.03 | — | — | |
| Petrolatum | — | — | — | — | — | 0.5 | — | — | 0.5 | — | |
| glycerol | — | — | | 2 | — | — | — | — | — | 1 | — |
| Minors | Balance to 100% with water | | | | | | | | | | |
| pH | 9 | 9 | 8.7 | 7 | 7 | 6.5 | 6 | 7 | 9 | 8.5 | 9.2 |

*Minors: dyes, perfumes, preservatives, hydrotropes, processing aids, stabilizers
(1) From foam having foam density 33 kg/m³/60-90 shore D hardness/Blade mill grinded and
sieved fraction 50-355 microns
(2) Blade mill grinded and sieved fraction 250-355 microns60-90 shore D hardness
(3) Blade mill grinded and sieved fraction 150-250 microns60-90 shore D hardness
(4) Evonik Industries/75 shore D hardness
(5) J. Rettenmaier & Söhne Gmbh+Co.KG 81 shore D hardness
(6) Ecoshell/80 shore D hardness
(7) Guar hydroxypropyl trimonium chloride
(8) Millithix 925S Milliken
(9) N,N'-(2S ,2'S)-1,1'-(dodecane-1,12-diylbis(azanediyl))bis(3-methyl-1-oxobutane-2,1- diyl)diisonicotinamide
(10) Acusol™ OP301 ex. Rohm and Haas

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid hand dishwashing composition comprising:
a. at least one surfactant; and
b. natural abrasive particles comprising pistachio nut shell particles.

2. A composition according to claim 1 wherein said natural abrasive particles consist of pistachio nut shell particles.

3. A composition according claim 1 wherein said pistachio nut shell particle has a average degree of whiteness (L*) of greater than 65, measured under D 65 illumination.

4. A composition according claim 1 wherein said pistachio nut shell particle has a average degree of whiteness (L*) of greater or equal to 80, measured under D 65 illumination.

5. A composition according to claim 1 wherein said natural abrasive particles have a Shore D hardness of from 40 to 90.

6. A composition according to claim 1 wherein said natural abrasive particles have a Shore D hardness of from 70 to 80.

7. A composition according to claim 1 wherein said natural abrasive particles are comprised at a level of greater than 0.5 by weight of the total composition.

8. A composition according to claim 1 wherein said natural abrasive particles are comprised at a level of from 2.5% to 10%, by weight of the total composition.

9. A composition according to claim 1 wherein said composition further comprises at least one suspending aid selected from the group consisting of crystalline wax suspending aids, amido-gellants, micro fibril cellulose, di-benzylidene polyol acetal derivatives, and mixtures thereof.

10. A composition according to claim 1 wherein said at least one surfactant is comprised at a level of from 1.0% to 50% by weight of the total composition, and is selected from the group consisting of anionic surfactants, non-ionic surfactants, and mixtures thereof.

11. A composition according to claim 1 wherein said pistachio nut shell particles are derived from Pistachia L. vera, Pistachia. terebinthus, Pistacia altantica species.

12. A composition according to claim 1, wherein said pistachio nut shell particles are derived from the Kerman, Muntaz, Pontikis, Sirora, Joley, Cerasola, Aegina, Bronte, Trabonella, Red Aleppo, Damghan, and/or Lassen cultivar.

13. A composition according to claim 1 wherein said pistachio nut shell particles are derived from the Pistachia L. vera species and Kerman cultivar.

14. A composition according to claim 1 further comprising polymeric abrasive particles derived from a polymeric material foam wherein the ratio of said natural abrasive particles to said polymeric abrasive particles is from 50 to 1.

15. A composition according to claim 1 further comprising polymeric abrasive particles derived from a polymeric material foam wherein the ratio of said natural abrasive particles to said polymeric abrasive particles is from 5 to 1.

16. A composition according to claim 1 wherein said natural abrasive particles have a mean circularity of from 0.1 to 0.7.

17. A method of washing dishes comprising the steps of treating a hard surface with a composition according to claim 1.

18. The use of pistachio nut shell particles in a liquid hand dishwashing composition according to claim 1 for delivering a benefit selected from the group consisting of mild skin exfoliation, grease or stubborn soil cleaning, product aesthetics, and mixtures thereof.
